(19) United States
(12) Patent Application Publication
(10) Pub. No.: US 2005/0002693 A1
(43) Pub. Date: Jan. 6, 2005

(54) Automatic belt tension apparatus of image forming device

(75) Inventors: Ki-Ju Pak, Yongin (KR); Hyo-jin Lee, Suwon (KR); Il-kwon Kang, Suwon (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/801,850

(22) Filed: Mar. 17, 2004

(30) Foreign Application Priority Data
Jul. 2, 2003 (KR) 2003-44708

(51) Int. Cl. G03G 15/00

(52) U.S. Cl. 399/165; 399/302

(57) ABSTRACT

An automatic belt tension apparatus of an image forming device having: a tension applying part to apply a predetermined tension to the belt, installed with respect to the belt; a tension releasing part to operate the tension applying part to not apply the predetermined tension to the belt, installed with respect to the tension applying part; and a tension actuating part to actuate the tension applying part to apply the predetermined tension to the belt against the tension releasing part during operation of a driving unit, installed with respect to the driving unit and the tension releasing part. According to different embodiments, the belt may be a transfer belt, an intermediate belt, or a photosensitive belt.

### CROSS-REFERENCE TO RELATED APPLICATIONS

This application claims the benefit of Korean Patent Application No. 2003-44708, filed on Jul. 2, 2003, in the Korean Intellectual Property Office, the disclosure of which is incorporated herein by reference.

### BACKGROUND OF THE INVENTION

1. Field of the Invention

The present invention relates to an image forming device such as a printer, a copier, and a Fax, and more particularly, to an automatic belt tension apparatus of an image forming device that can automatically apply a predetermined tension to a transfer belt or a photosensitive belt only when a belt unit such as a transfer unit or an intermediate transfer unit, comprising the transfer belt, or a photosensitive body comprising the photosensitive belt, is operated.

2. Description of the Related Art

In general, a typical electrophotograph color image forming device is provided with: a plurality of image forming units; a plurality of photosensitive bodies, each on which a toner image of color different from one another is formed by the corresponding respective image forming units; a transfer unit having a transfer belt or a transfer roller sequentially transferring the toner images formed on the photosensitive bodies to a recording medium such as a sheet of paper; and a fusing unit fixing the toner images transferred onto the recording medium with a heat and a pressure.

Another color image forming device comprises an intermediate transfer unit having an intermediate transfer element such as a transfer belt disposed between the photosensitive bodies and the transfer unit. In this case, the toner images formed on the photosensitive bodies are not directly transferred to the recording medium, but first formed as a first transfer image on the intermediate transfer element and then transferred to the recording medium.

These color image forming devices generally use a plurality of photosensitive drums, each forming a toner image of color different from one another thereon, as the plurality of photosensitive bodies. But some image forming devices, for example, a wet type image forming device, use one photosensitive belt instead of the plurality of photosensitive drums. In this case, toner images of colors different from one another are formed on the photosensitive belt by a plurality of developing parts forming the image forming units, transferred onto the recording medium via the transfer roller of the transfer unit, and then fixed on the recording medium by the fusing unit.

Also, in these color image forming devices, a tension apparatus is used to maintain the transfer belt installed in the transfer unit or the intermediate transfer unit, or the photosensitive belt used instead of the photosensitive drums in a tensioned state of coming in contact with the photosensitive drums or the transfer roller of the transfer unit in a predetermined pressure during the transfer operation or the image forming operation.

FIGS. 1 and 2 show an intermediate transfer unit 10 of a general color image forming device using a transfer belt as an intermediate transfer element.

The intermediate transfer unit 10 is provided with: an intermediate transfer belt 9 changing toner images formed on photosensitive bodies 11Y, 11M, 11C, 11K by image forming units (not shown) into a first transfer image; first transfer rollers 15Y, 15M, 15C, 15K pressing the photosensitive bodies 11Y, 11M, 11C, 11K with a predetermined pressure with the intermediate transfer belt 9 interposed therebetween; and a transfer belt tension apparatus 20 applying a predetermined tension to the intermediate transfer belt 9 to allow the intermediate transfer belt 9 and the photosensitive bodies 11Y, 11M, 11C, 11K to be in contact with each other with a predetermined pressure.

The intermediate transfer belt 9 is rotatably installed on a driving roller 7 supported on a frame 1 by: a driving shaft 3 having a driving gear 5; supporting and backup rollers 13 and 15, which are respectively supported on the frame 1 by corresponding shafts 13a and 15a; and a second transfer backup roller 8 supported on the frame 1 by corresponding shaft 8a.

At a lower part of the second transfer backup roller 8, a transfer roller 17 of a second transfer unit (not shown), which transfers the first transfer image formed on the intermediate transfer belt 9 onto a sheet of paper, comes in contact with the intermediate transfer belt 9 with a predetermined pressure.

The transfer belt tension apparatus 20 is provided with a swing shaft 25 having both ends supported at the frame 1, a tension roller 21 coming in contact with an inner surface of the intermediate transfer belt 9, a swing arm 23 connecting the tension roller 21 to the swing shaft 25, and a tension spring 27 imparting an elastic rotating force to the swing shaft 25 in a direction of enabling the tension roller 21, connected to the swing shaft 25 through the swing arm 23, to be in contact with the inner surface of the intermediate transfer belt 9.

The tension spring 27 has one end 27a supported in a first fixing groove 24a positioned at the swing arm 23 and an other end 27b supported in a second fixing groove 29a of a spring boss 29 positioned at the frame 1.

Accordingly, the tension spring 27 urges the tension roller 21 to always push the intermediate transfer belt 9 in a direction of arrow A of FIG. 1, and thereby the intermediate transfer belt 9 is maintained in a tensioned state to contact the photosensitive bodies 11Y, 11M, 11C, 11K with the predetermined pressure.

But, the conventional intermediate transfer unit 10 constructed as above when used for a long period of time, may present a problem. Since the tension roller 21 is continuously applying the tension to the intermediate transfer belt 9, the length of the intermediate transfer belt 9 grows longer, thereby inducing speed deviation during the transfer operation.

Also, with the conventional intermediate transfer unit 10, when left as it is without being used for a long period of time, the intermediate transfer belt 9 may generate traces at portions thereof coming in contact with the driving roller 7, the supporting and backup rollers 13 and 15, and the second transfer backup roller 8, thereby degrading a quality of the image formed during the transfer operation.

These problems may occur in the transfer unit using the transfer belt and the photosensitive body composed of the photosensitive belt, as well as the conventional intermediate transfer unit 10.

### SUMMARY OF THE INVENTION

It is, therefore, an aspect of the present invention to provide an automatic belt tension apparatus of an image forming device, which can apply a predetermined tension to a photosensitive belt or a transfer belt only when a belt unit such as a transfer unit or an intermediate transfer unit comprising the transfer belt, or a photosensitive body composed of the photosensitive belt is operated, so that even though the image forming device is used for a long period of time or left as it is for a long period of time, the photosensitive belt or the transfer belt can be prevented form being expanded or generating traces at portions thereof coming in contact with driving and supporting rollers, thereby extending life of the transfer belt or the photosensitive belt and the image forming device using the same and at the same time, maintaining a quality in image in a regular level for a long period of time.

To achieve the above aspect and/or other aspects of the present invention, there is provided an automatic belt tension apparatus for an image forming device including at least one belt having an image adhesion face to attach and transfer a developer image at a first surface thereof, and a driving unit supporting the belt and driving the belt to rotate, the apparatus comprising a tension applying part to apply a predetermined tension to the belt, installed with respect to the belt, a tension releasing part operating the tension applying part to not apply the predetermined tension to the belt, installed with respect to the tension applying part, and a tension actuating part, to actuate the tension applying part to apply the predetermined tension to the belt against the tension releasing part, only during operation of the driving unit, installed with respect to the driving unit and the tension releasing part.

According to one aspect, the tension applying part is provided with: a swing shaft having ends supported at a frame; a tension roller selectively coming in contact with a second surface of the belt; and a swing arm, fixed on the swing shaft, and rotatably supporting the tension roller.

According to one aspect, the tension applying part further comprises: a first elastic member exerting a first elastic rotating force on the swing arm, to swing the tension roller in a first direction of contacting with the second surface of the belt, installed with respect to the swing shaft, the frame, and the swing arm.

According to one aspect, the first elastic member comprises a first tension spring, installed with respect to the swing shaft, and having ends supported at the frame and the swing arm, respectively.

According to one aspect, the tension releasing part comprises a second elastic member exerting a second elastic rotating force on the swing arm, to swing the tension roller in a second direction, opposite the first direction, installed with respect to the frame and the swing arm.

According to one aspect, the second elastic member comprises a second tension spring installed with respect to the swing arm, and having ends supported at the frame and the swing arm, respectively. According to one aspect, the second elastic rotating force of the second tension spring is greater than the first elastic rotating force of the first tension spring, so that the tension roller swings in the second direction, and thereby is biased to not apply the predetermined tension to the belt.

According to one aspect, the tension actuating part comprises: a tension gear installed on the driving unit; a power transmitting gear train comprising a plurality of power transmitting gears connected with the tension gear; and a tension clutch installed on the swing shaft and transmitting a driving force transmitted to the power transmitting gear train from the tension gear, to the swing shaft only when the driving force is in a range of a predetermined load torque.

According to one aspect, the tension clutch comprises: a clutch gear, rotatably installed on the swing shaft to engage with the power transmitting gear train, and having a first clutch boss extended in an axial direction; a bushing having a second clutch boss fixed on the swing shaft; and a clutch spring coiled on outer circumferential surfaces of the first clutch boss of the clutch gear and the second clutch boss of the bushing, and when the driving force is transmitted from the power transmitting gear train to clutch gear, transmitting the driving force to the bushing fixed on the swing shaft only when a driving load of the clutch gear is in the range of the predetermined load torque.

According to one aspect, the range of the predetermined load torque of the clutch gear is set such that the tension roller, fixed on the swing shaft through the swing arm, applies the predetermined tension to the belt against the second elastic member of the tension releasing part.

According to one aspect, the belt comprises a transfer belt, to receive a developer image formed on at least one photosensitive drum at the image adhesion face thereof, and to transfer the developer image onto a recording medium.

According to one aspect, the belt comprises an intermediate transfer belt, to receive a developer image formed on at least one photosensitive drum at the image adhesion face thereof, and to transfer the developer image onto a transfer roller, to transfer the developer image onto a recording medium.

According to one aspect, the belt comprises a photosensitive belt to form a developer image at the image adhesion face thereof.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic side elevation view of a general intermediate transfer unit of an image forming device;

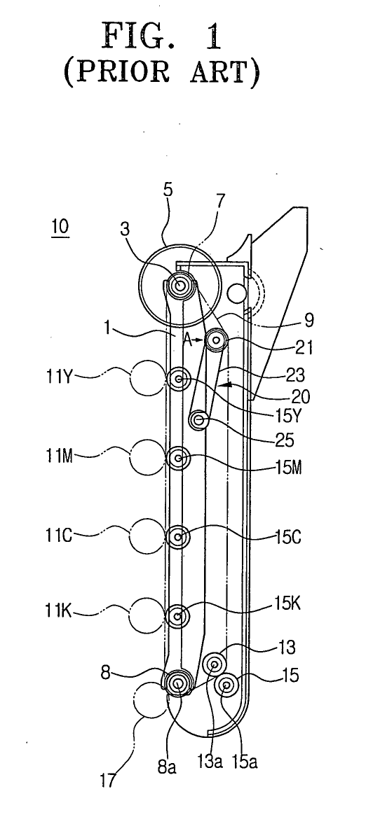

FIG. 2 is a partial front elevation view of an transfer belt tension apparatus of the intermediate transfer unit shown in FIG. 1;

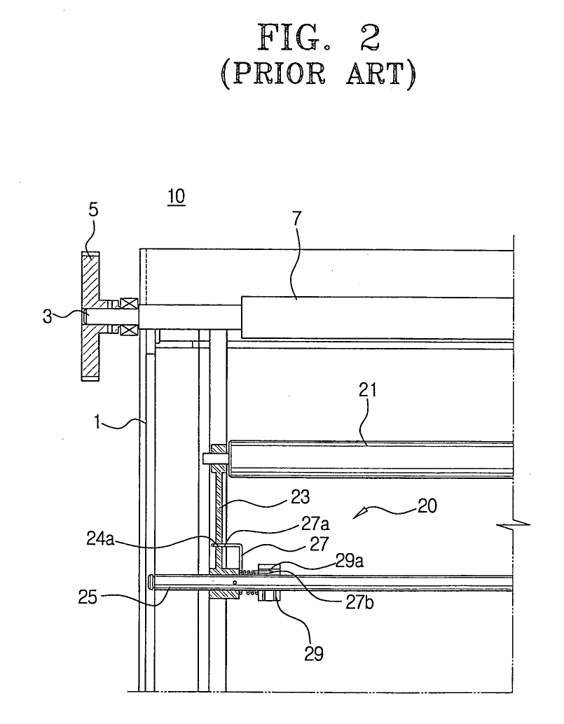

FIG. 3 is a schematic side elevation view of an intermediate transfer unit of an image forming device to which an automatic belt tension apparatus is applied according to a first embodiment of the present invention;

FIG. 4 is a partial front elevation view of the automatic belt tension apparatus of FIG. 3;

FIG. 5 is a cross-sectional view of a spring clutch of the automatic belt tension apparatus of FIG. 4;

FIG. 6 is a schematic side elevation view of a wet electrophotograph color printer with an automatic belt tension apparatus according to a second embodiment of the present invention; and

FIG. 7 is a partial front elevation view of the automatic belt tension apparatus of FIG. 6.

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. The embodiments are described below to explain the present invention by referring to the figures.

Embodiment 1

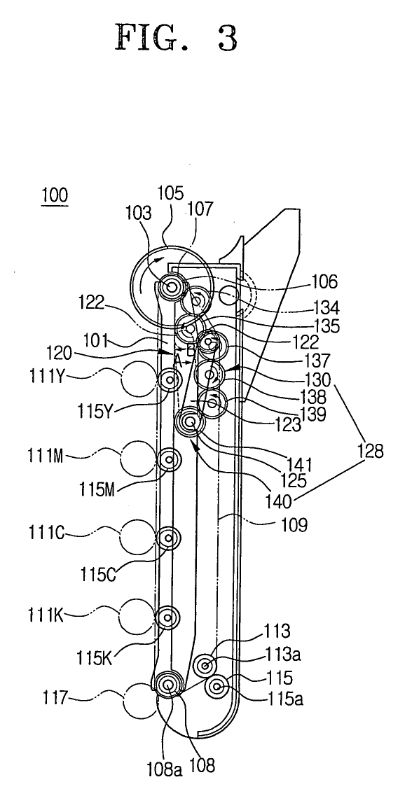

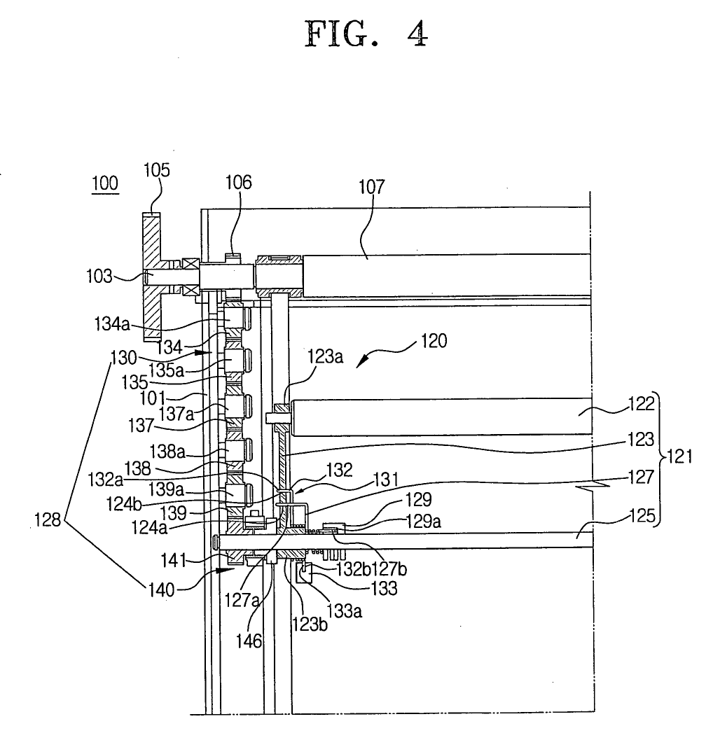

Referring to FIGS. 3 and 4, there is illustrated an intermediate transfer unit 100 of an electrophotograph color printer, to which an automatic belt tension apparatus 120 is applied, according to a first embodiment of the present invention.

The intermediate transfer unit 100 comprises: an intermediate transfer belt 109 changing toner images formed on four drum-shaped photosensitive bodies 111Y, 111M, 111C, 111K, each of which is respectively disposed in four image forming units (not shown) for forming toner images of yellow, magenta, cyan and black colors, into a first transfer image; four first transfer rollers 115Y, 115M, 115C, 115K pressing the photosensitive bodies 111Y, 111M, 111C, 111K with a first predetermined pressure with the intermediate transfer belt 109 interposed therebetween; and the automatic belt tension apparatus 120 applying a predetermined tension to the intermediate transfer belt 109, to allow the intermediate transfer belt 109 and the photosensitive bodies 111Y, 111M, 111C, 111K be in contact with each other with a second predetermined pressure.

The intermediate transfer belt 109 is wound to be rotatable on: a driving roller 107 supported on a frame 101 by a driving shaft 103, supporting and backup rollers 113 and 115 supported on the frame 101 by corresponding shafts 113a and 115a, and a second transfer backup roller 108 supported on the frame 101 by corresponding shaft 108a.

The driving shaft 103 is provided with a driving gear 105 connected with a driving motor (not shown) through a gear train (not shown), and a tension gear 106 driving a power transmitting gear train 130 of a tension actuating part 128, positioned between the driving gear 105 and the driving roller 107. The tension gear 106 constitutes a portion of the tension actuating part 128.

At a lower part of the second transfer backup roller 108, a transfer roller 117 of a second transfer unit (not shown), which transfers the first transfer image formed on the intermediate transfer belt 109 onto a sheet of paper, is disposed to come in contact with the intermediate transfer belt 109.

The automatic belt tension apparatus 120 comprises: a tension applying part 121 (FIG. 4) installed with respect to the intermediate transfer belt 109 and applying the predetermined tension to the intermediate transfer belt 109 to allow the transfer belt 109 to be in contact with the photosensitive bodies 111Y, 111M, 111C, 111K with the second predetermined pressure; a tension releasing part 131 installed with respect to the tension applying part 121 and operating the tension applying part 121 to not apply the predetermined tension to the intermediate transfer belt 109; and the tension actuating part 128 installed with respect to the tension releasing part 131 and the driving shaft 103 supporting the driving roller 107 to drive the intermediate transfer belt 109, and actuating the tension applying part 121 to apply the predetermined tension to the intermediate transfer belt 109 against the tension releasing part 131 only when the driving shaft 103 is rotated by the driving gear 105.

The tension applying part 121 is provided with a swing shaft 125 having both ends supported at the frame 101, a tension roller 122 coming in contact with an inner surface of the intermediate transfer belt 109, and a swing arm 123 having a first boss 123a rotatably supporting the tension roller 122 and a second boss 123b fixed on the swing shaft 125.

According to one aspect, to assist swinging the tension roller 122 in a direction of coming in contact with the inner surface of the intermediate transfer belt 109 when the tension actuating part 131 is operated to apply the predetermined tension to the intermediate transfer belt 109, the tension applying part 121 further compriss a first elastic member 127 installed with respect to the frame 101, the swing shaft 125 and the swing arm 123.

The first elastic member 127 imparts a first elastic rotating force to the swing arm 123 to swing the tension roller 122 in the direction of contacting the inner surface of the intermediate transfer belt 109.

The first elastic member 127 comprises a first tension spring installed on the swing shaft 125 and having a first end 127a supported in a first fixing groove 124a positioned at the swing arm 123 and a second end 127b supported in a second fixing groove 129a of a first spring boss 129 positioned on the frame 101.

The tension releasing part 131 is provided with a second elastic member 132 installed with respect to the frame 101 and the swing arm 123. The second elastic member 132 imparts a second elastic rotating force to the swing arm 123, to swing the tension roller 122 in a direction opposite to the direction of contacting the inner surface of the intermediate transfer belt 109.

The second elastic member 132 comprises a second tension spring, installed on the second boss 123b of the swing arm 123 fixed on the swing shaft 125, and having a first end 132a supported in a third fixing groove 124b positioned in the swing arm 123, and a second end 132b supported in a fourth fixing groove 133a positioned in a second spring boss 133 formed on the frame 101.

According to one aspect, the second elastic force of the second tension spring 132 is larger than the first elastic force of the first tension spring 127, to bias the tension roller 122 in the opposite direction of coming in contact with the inner surface of the intermediate transfer belt 109, and thereby not apply the predetermined tension to the intermediate transfer belt 109.

Accordingly, the tension roller 122 is maintained at a standby position shown in a dotted line of FIG. 3, which is pushed in a direction of arrow B by the elastic force of the second elastic member 132, to come in contact with the frame 101, and not apply the predetermined tension to the intermediate transfer belt 109.

The tension actuating part 128 is provided with: the tension gear 106 installed on the driving shaft 103; the power transmitting gear train 130, comprising first, second, third, fourth, and fifth power transmitting gears 134, 135, 137, 138, and 139 connected with the tension gear 106; and a tension clutch 140 installed on the swing shaft 125 and transmitting a driving force transmitted to the power transmitting gear train 130 from the tension gear 106, to the swing shaft 125 of the tension applying part 121 only when the driving force is in a range of a predetermined load torque.

The first, second, third, fourth, and fifth power transmitting gears 134, 135, 137, 138, and 139 of the power transmitting gear train 130, are respectively supported on the frame 101 by first, second, third, fourth, and fifth supporting shafts 134a, 135a, 137a, 138a, and 139a.

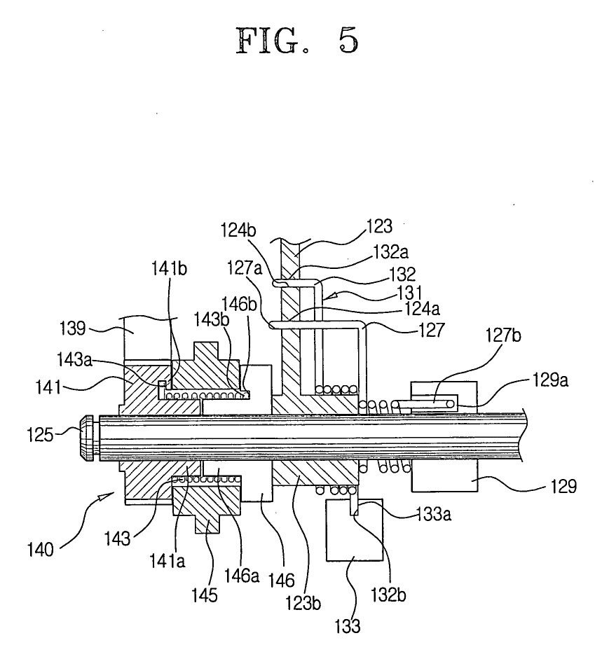

As shown in FIG. 5, the tension clutch 140 comprises: a clutch gear 141 rotatably installed on the swing shaft 125, to engage with the fifth power transmitting gear 139 of the power transmitting gear train 130, and having a first clutch boss 141a extended in an axial direction; a bushing 146 having a second clutch boss 146a fixed on the swing shaft 125; and an elastic clutch member 143, or a clutch spring 143, coiled on outer circumferential surfaces of the first clutch boss 141a of the clutch gear 141 and the second clutch boss 146a of the bushing 146, to generate a sliding friction force therebetween. Thus, when the driving force of the tension gear 106 is transmitted from the fifth power transmitting gear 139 of the power transmitting gear train 130 to the clutch gear 141, the clutch spring 143 only transmits the driving force to the bushing 146 fixed on the swing shaft 125 when the driving force, i.e., a rotating force of the clutch gear 141, is in the range of the predetermined load torque.

The clutch spring 143 is wound in a direction that the clutch gear 141 rotates, for example, in a clockwise direction, so that the clutch gear 141 can transmit the rotating force thereof to the bushing 146 when it is rotated by the fifth power transmitting gear 139 of the power transmitting gear train 130.

Around the clutch spring 143, a clutch ring 145 is disposed to enclose the clutch spring 143. The clutch ring 145 is movably supported over the bushing 146.

Also, the clutch spring 143 has a first end 143a slipably supported by a first support 141b, and a second end 143b fixedly supported by a second support 146b, comprising a groove formed in the vicinity of an inner edge of an outer surface of the bushing 146. According to one aspect, the first support 141b comprises a circular-shaped concavo-convex groove. At another aspect, the first support 141b comprises a plurality of spaced-apart grooves circumferentially positioned adjacent to an inner edge of an outer surface of the first clutch boss 141a of the clutch gear 141.

Since the first end 143a of the clutch spring 143 is slipably supported by the first support 141b of the clutch gear 141, when the rotating force of the clutch gear 141 exceeds the range of the predetermined load torque, the first end 143a of the clutch spring 143 slips over the first support 141b, and thereby the first clutch boss 141a comes in slide contact with the clutch spring 143, so that the clutch gear 141 idles and does not transmit the rotating force thereof to the bushing 146.

Two embodiments of the first support 141b are described above, namely, the circular-shaped concavo-convex groove and the plurality of spaced-apart grooves. It should be noted, however, that the first support 141b may be any other form capable of slipably supporting the first end 143a of the clutch spring 143, for example, a projection or a plurality of circumferentially spaced-apart projections formed on an inner edge of the outer surface of the first clutch boss 141a of the clutch gear 141.

Also, only the first end 143a of the clutch spring 143 is described as slipably supported by the first support 141b, but according to one aspect, both the first and second ends 143a and 143b of the clutch spring 143 are slipably supported by the first and the second supports 141b and 146b. According to another aspect, only the second end 143b of the clutch spring 143 is slibably supported by the second support 146b.

To say nothing of the construction, according to one aspect, the range of the predetermined load torque of the clutch gear 141 of supporting the first and/or second ends 143a, 143b of the clutch spring 143 without slip is such that the tension roller 122, fixed on the swing shaft 125 through the swing arm 123, is capable of applying the predetermined tension to the intermediate transfer belt 109 against the second elastic member 132 of the tension releasing part 131, to assure that the intermediate transfer belt 109 is in contact with the photosensitive bodies 111Y, 111M, 111C, 111K with the predetermined pressure.

In the first embodiment described above, the automatic belt tension apparatus 120 of the intermediate transfer unit 100 is illustrated and explained as only applying the predetermined tension to the intermediate transfer belt 109, but the present invention is not limited to this, and may also be applied to any other apparatus using a transfer belt, for example, a transfer unit (not shown) having a transfer belt (not shown), which directly transfers the toner images formed on the photosensitive bodies 111Y, 111M, 111C, 111K onto the sheet of paper.

The operation of the automatic belt tension apparatus 120 of the intermediate transfer unit 100 according to the first embodiment of the present invention constructed as above will now be explained in great detail with reference to FIGS. 3 through 5.

Firstly, after toner imagers are formed on the photosensitive bodies 111Y, 111M, 111C, 111K in a known manner in the art, to change the toner images into a first transfer image, the driving roller 107 of the intermediate transfer unit 100 is rotated in one direction, for example, a clockwise direction by a driving gear 105 connected with the driving motor through a gear train (not shown), as is shown in the embodiment depicted in FIG. 3.

As the driving roller 107 rotates, the intermediate transfer belt 109 begins to rotate along the supporting and backup roller 113 and 115 and the second transfer backup roller 108, coming in contact with the photosensitive bodies 111Y, 111M, 111C, 111K and the transfer roller 117, and at the same time, the tension gear 106 positioned on the driving shaft 103 rotates in the clockwise direction.

As the tension gear 106 rotates, the first, second, third, fourth, and fifth power transmitting gears 134, 135, 137, 138, and 139 of the power transmitting gear train 130 connected with the tension gear 106, sequentially rotate, and as a result, the clutch gear 141 engaged with the fifth power transmitting gear 139 rotates in the winding direction of the clutch spring 143, i.e., the clockwise direction of FIG. 3.

As is described above, when the clutch gear 141 rotates in the clockwise direction, the clutch spring 143, supported by the first and the second supports 141b and 146b at the first and the second ends 143a and 143b thereof, comes in tight contact with the outer circumferential surfaces of the first and the second clutch bosses 141a and 146a, while the inner diameter of the clutch spring 143 gets smaller and generates a sliding friction force with the first and the second clutch bosses 141a and 146a, so that a rotating force of the first clutch boss 141a of the clutch gear 141 is transferred to the second clutch boss 146a of the bushing 146, near the clutch gear 141.

The rotating force of the clutch gear 141, transmitted to the second clutch boss 146a of the bushing 146 as described above, is transmitted to the swing arm 123 through the swing shaft 125, and as a result, the swing arm 123 swings the tension roller 122 from a standby position, shown in a dotted line in FIG. 3, to a tension position, shown in a solid line in FIG. 3, against an elastic force of the second elastic member 132 of the tension releasing part 131.

At this time, the first elastic member 127 of the tension applying part 121 assists rotation of the swing shaft 125 in the clockwise direction against the elastic force of the second elastic member 132 of the tension releasing part 131, so that the swing arm 123 can more easily swing in the clockwise direction.

As the swing arm 123 swings as described above, the tension roller 122, rotatably supported on the first boss 123a of the swing arm 123, presses the inner surface of the intermediate transfer belt 109 in a direction of arrow A in FIG. 3, to apply the predetermined tension thereto.

After that, when the tension roller 122 is no longer swung, and is stopped by the tensioned intermediate transfer belt 109, the clutch gear 141 connected with the tension roller 122 through the swing arm 123 and the swing shaft 125 is no longer rotated, thereby generating a driving load by the driving force from the power transmitting gear train 130.

When the driving load of the clutch gear 141 generated as above exceeds the range of the predetermined load torque, i.e., the limit set to enable the intermediate transfer belt 109 to be in contact with the photosensitive bodies 111Y, 111M, 111C, 111K with the second predetermined pressure, the first end 143a of the clutch spring 143 does not stand the excess driving load of the clutch gear 141, and slips over the first support 141b, and thereby, the circumferential surface of the first clutch boss 141a no longer comes in tight contact with the clutch spring 143, and slides therein to idle the clutch gear 141.

At this time, since the friction force between the clutch spring 143 and the circumferential surfaces of the first and the second clutch bosses 141a and 146a is not completely removed, but maintained to the extent to allow only the idling of the clutch gear 141, the intermediate transfer belt 109 remains in contact with the photosensitive bodies 111Y, 111M, 111C, 111K with the second predetermined pressure.

Also, under this condition, if the driving load of the clutch gear 141 falls below the range of the predetermined load torque, due to moving or shaking of the intermediate transfer belt 109 by an external force and the like, the first end 143a of the clutch spring 143 stops slipping over the first support 141b, and thereby the clutch spring 143 is again coiled in the winding direction thereof by the rotation of the clutch gear 141. Consequently, the clutch spring 143 comes in tight contact with the outer circumferential surfaces of the first and the second clutch bosses 141a and 146a while the inner diameter of the clutch spring 143 gets smaller, and generates the sliding friction force so as not to allow the first clutch bosses 141a of the clutch gear 141 to slide and idle therein, so that the rotating force of the first clutch boss 141a of the clutch gear 141 is again transferred to the second clutch boss 146a of the bushing 146 nearby the clutch gear 141.

Thereafter, when the driving load of the clutch gear 141 again exceeds the range of the predetermined load torque, the tension clutch 140 operates the clutch gear 141 to idle in the clutch spring 143 in the same manner as is described above.

As described above, while the intermediate transfer belt 109 comes in contact with the photosensitive bodies 111Y, 111M, 111C, 111K with the second predetermined pressure, the toner images formed on the photosensitive bodies 111Y, 111M, 111C, 111K by the image forming units for the yellow, cyan, magenta, and black colors is transferred onto an outer surface of the intermediate transfer belt 109, which is rotating at the same speed as the photosensitive bodies by the driving roller 107, and changed into a first transfer image.

After that, the first transfer image, transferred onto the outer surface of the intermediate transfer belt 109, is transferred in the known manner in the art onto a sheet of paper conveyed by a paper feeding unit (not shown) through the transfer roller 117 of the second transfer unit. The sheet of paper with the transferred image is then moved to the fusing unit to fix the transferred image on the sheet of paper, and is then discharged to the outside.

As is described above, after the printing is completed, when the driving motor driving the driving roller 107 of the intermediate transfer unit 100 is stopped, the driving load, which acts on the swing arm 123 connected to the tension roller 122 through the tension gear 106, the power transmitting gear train 130, the clutch gear 141, the bushing 146, and the swing shaft 125, disappears, and thereby the second elastic member 132 of the tension releasing part 131 moves the tension roller 122 from the tension position, shown in the solid line in FIG. 3, to the standby position, shown in the dotted line of FIG. 3, against the elastic force of the first elastic member 127. Accordingly, the tension of the intermediate transfer belt 109, on which the tension roller 122 acts, is released.

Embodiment 2

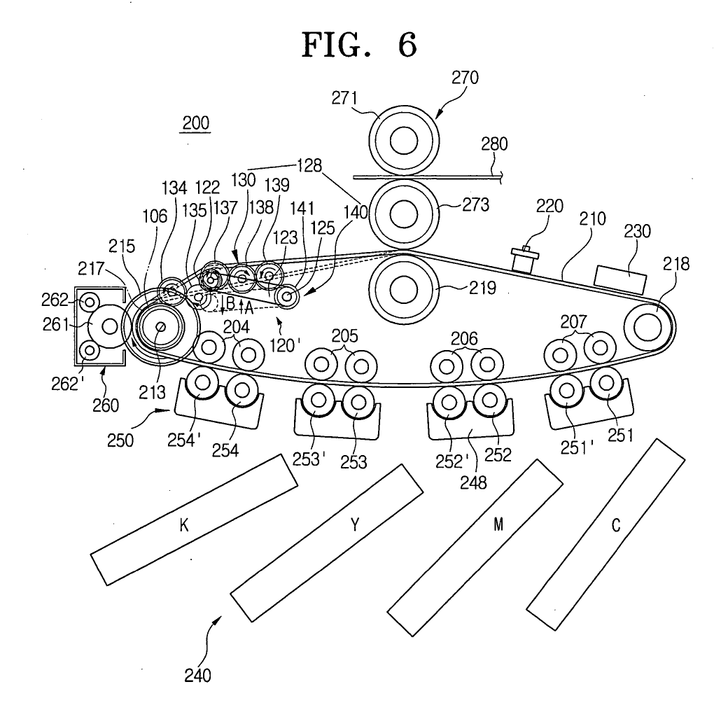

Referring to FIG. 6, there is schematically illustrated a wet electrophotograph color printer 200 to which an automatic belt tension apparatus 120′ is applied according to a second embodiment of the present invention.

The wet electrophotograph color printer 200 comprises: a photosensitive belt 210 rotating along an endless path by driving, backup, and driven rollers 217, 219, and 218, respectively: an erasing unit 220 to remove electric potential remaining on a surface of the photosensitive belt 210, that is disposed over a side of the photosensitive belt 210; a charging unit 230 to electrify the surface of the photosensitive belt 210, from which the remaining electric potential has been removed, with a predetermined electric potential; a laser scanning unit 240 to scan a laser beam, modulated according to an image signal, onto the surface of the photosensitive belt 210, to form an electrostatic latent image thereon; a developing unit 250 to develop the electrostatic latent image into a visible image by supplying a developer 248, in which a solid toner is mixed with a liquid carrier, to the surface of the photosensitive belt 210, and attaching only the solid toner contained in the developer 248 on the electrostatic latent image and removing the liquid carrier contained in the developer 248; a drying unit 260 to absorb the liquid carrier remaining in the solid toner attached on the electrostatic latent image, and dry and remove the absorbed liquid carrier; a transfer and fusing unit 270 to transfer the solid toner attached on the electrostatic latent image onto a sheet of paper 280 and then fix it on the sheet of paper 280; and the automatic belt tension apparatus 120′ to automatically apply a predetermined tension to the photosensitive belt 210 only when the photosensitive belt 210 is driven by the driving roller 217.

The laser scanning unit 240 and the developing unit 250 are respectively comprised of four laser scanning parts Y, M, C, and K, performing color printing, and four developing parts, developing the developer 248 of four colors such as black, yellow, cyan, and magenta. Each of the developing parts has developing and backup rollers 251, 252, 253, and 254; 204, 205, 206, and 207 to attach the developer 248 to the electrostatic latent image formed on the photosensitive belt 210, and a squeeze roller 251′, 252′, 253′ and 254′ to compress the developer 248 attached on the electrostatic latent image of the photosensitive belt 210, to change the solid toner contained in the developer 248 into an image film, i.e. a toner image, and to remove the liquid carrier except for the solid toner contained in the developer 248 when the developer 248 is supplied on the photosensitive belt 210.

The drying unit 260 is provided with a dry roller 261 to absorb the liquid carrier that is not removed from the solid toner, attached on the electrostatic latent image, by the squeeze rollers 251′, 252′, 253′ and 254′, and regeneration rollers 262, 262′ to heat and vaporize the absorbed liquid carrier.

The transfer and fusing unit 270 comprises a transfer roller 273, to receive the solid toner formed as the toner image on the photosensitive belt 210 and to transfer it onto the sheet of paper 280; and a pressing roller 271 to press the sheet of paper 280 against the transfer roller 273 with a high temperature and a high pressure, and at the same time, fuse the toner image transferred on the sheet of paper 280 and fix it thereon.

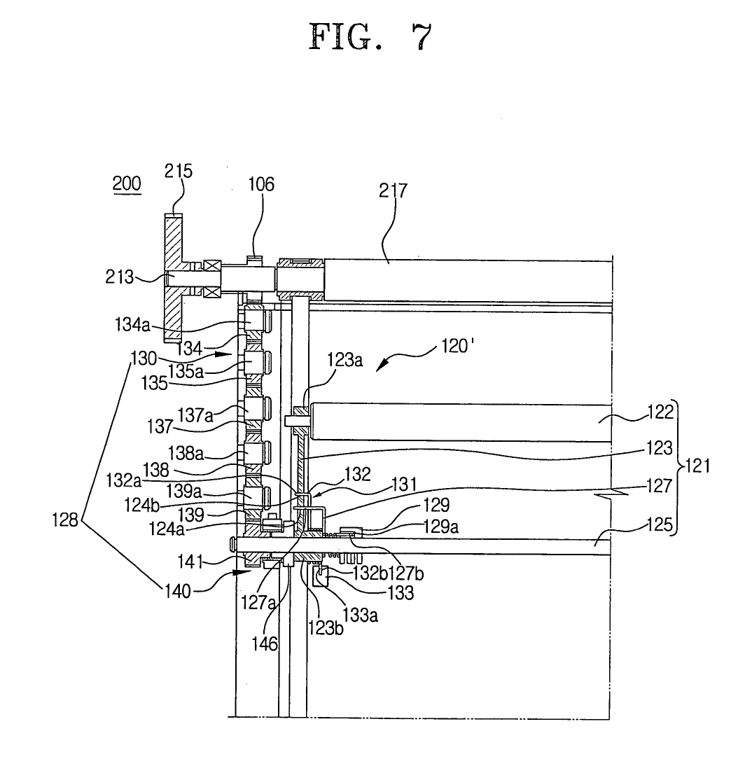

As is shown in FIG. 7, the automatic belt tension apparatus 120′ comprises: the tension applying part 121 applying the predetermined tension to the photosensitive belt 210, that is installed with respect to the photosensitive belt 210; the tension releasing part 131 operating the tension applying part 121 not to apply the predetermined tension to the photosensitive belt 210, that is installed with respect to the tension applying part 121; and the tension actuating part 128 actuating the tension applying part 121 to apply the predetermined tension to the photosensitive belt 210 against the tension releasing part 131 only when a driving shaft 213 is rotated by a driving gear 215, that is installed with respect to the tension releasing part 131 and the driving shaft 213 supporting the driving roller 217, to drive the photosensitive belt 210.

The description of the tension applying part 121, the tension releasing part 131, and the tension actuating part 128 will be omitted here, as it is identical to that of the automatic belt tension apparatus 120 that is described above with reference to FIGS. 4 and 5.

The operation of the wet electrophotograph color printer 200 having the automatic belt tension apparatus 120′ according to the second embodiment of the present invention constructed as above will now be explained in great detail with reference to FIGS. 6 through 7.

Firstly, according to a printing command, the driving roller 217 is rotated in one direction, for example, a clockwise direction as shown in FIG. 6, by a driving gear 215 connected with a driving motor (not shown) through a gear train (not shown).

As the driving roller 217 rotates in the clockwise direction, the photosensitive belt 210 begins to rotate in the clockwise direction along the backup and driven rollers 219 and 218, and at the same time, the tension gear 106, positioned on the driving shaft 213 of the driving roller 217, rotates in the clockwise direction.

As the tension gear 106 rotates in the clockwise direction, the swing arm 123, which is connected with the tension gear 106 through the power transmitting gear train 130, the clutch gear 141, the bushing 146, and the swing shaft 125, is swung in a direction of arrow A in the same manner as that of the automatic belt tension apparatus 120 of the first embodiment explained with reference to FIGS. 3 through 5. Thus, the tension roller 122, connected to the swing arm 123, is moved from a standby position, shown in the dotted line in FIG. 6, to the tension position, shown in the solid line in FIG. 6, against the elastic force of the second elastic member 132.

As a result, the photosensitive belt 210 is maintained in a state of coming in contact with the transfer roller 273, the developing rollers 251, 252, 253, and 254, the squeeze rollers 251′, 252′, 253′, and 254′ and the like in a predetermined pressure.

Under this condition, as the photosensitive belt 210 rotates in the clockwise direction, an electrostatic latent image corresponding to an image to be printed is formed on the photosensitive belt 210 by the charging unit 230 and the laser scanning unit 240. And the developer 248, composed of a solid toner and a liquid carrier, is attached on the electrostatic latent image due to the operation of the developing rollers 251, 252, 253, and 254 of the developing unit 250. As a result, the developer 248 forms a visible image on the area of the photosensitive belt 210 on which the electrostatic latent image is formed.

And then, the developer 248 attached on the electrostatic latent image of the photosensitive belt 210 by the developing rollers 251, 252, 253, and 254 is compressed by the squeeze rollers 251′, 252′. 253′, and 254′, so that the solid toner contained in the developer 248 is changed into an image film, i.e. a toner image, and the liquid carrier, except for the solid toner contained in the developer 248, is removed.

Thereafter, liquid carrier components remaining in the solid toner changed into the toner image are absorbed and removed by the dry roller 261, and the toner image is transferred from the photosensitive belt 210 to the transfer roller 273 by a transfer voltage of the transfer roller 273 and a pressure of the backup roller 219.

Then, the toner image transferred to the transfer roller 273 is transferred onto a sheet of paper 280, and at the same time, fused thereon by the pressing roller 271, which presses the sheet of paper 280 to the transfer roller 273 with a high pressure and a high temperature, applying a predetermined transfer voltage thereto. As a result, the toner image is fixed on the sheet of paper 280, and thus, a desired image is formed on the sheet of paper 280.

Additionally, after the toner image is transferred from the photosensitive belt 210 to the transfer roller 273, as the photosensitive belt 210 is continuously rotated in the clockwise direction by the driving roller 217, the electric potential on the surface of the photosensitive belt 210 is removed by the erasing unit 220.

Thereafter, the transfer belt 110 repeats the above described processes to form and develop a next electrostatic latent image to be printed using the charging unit 230, the laser scanning unit 240, and the developing unit 250.

As is described above, after the printing is completed, when the driving motor driving the driving roller 217 is stopped, the driving load, which acts on the swing arm 123 connected to the tension roller 122 through the tension gear 106, the power transmitting gear train 130, the clutch gear 141, the bushing 146, and the swing shaft 125, disappears. Thus, the second elastic member 132 of the tension releasing part 131 moves the tension roller 122 from the tension position, shown in the solid line in FIG. 6, to the standby position, shown in the dotted line in FIG. 6, against the elastic force of the first elastic member 127. Accordingly, the tension of the photosensitive belt 210 on which the tension roller 122 acts is released.

As is apparent from the forgoing description, it can be appreciated that the automatic belt tension apparatus of the image forming device according to the present invention can apply the predetermined tension to the transfer belt and the photosensitive belt during performance of the transfer operation and the image forming operation, respectively, so that even if the image forming device is used for a long period of time, or remains unused for a long period of time, the transfer belt and the photosensitive belt can be prevented from being expanded or generating traces at portions thereof coming in contact with the driving and supporting rollers and the like, thereby extending life of the transfer belt and the transfer unit, and the intermediate transfer unit having the same, and the photosensitive belt, and at the same time, maintaining an image quality at a regular level for a long period of time.

Although a few embodiments of the present invention have been shown and described, it would be appreciated by those skilled in the art that changes may be made in this embodiment without departing from the principles and spirit of the invention, the scope of which is defined in the claims and their equivalents.

1. An automatic belt tension apparatus for an image forming device including at least one belt having an image adhesion face to attach and transfer a developer image at a first surface thereof, and a driving unit supporting the belt and selectively driving the belt to rotate, the automatic belt tension apparatus comprising:
a tension applying part to apply a predetermined tension to the belt, installed with respect to the belt;
a tension releasing part operating the tension applying part to not apply the predetermined tension to the belt, installed with respect to the tension applying part; and
a tension actuating part, to actuate the tension applying part to apply the predetermined tension to the belt against the tension releasing part, only during operation of the driving unit, installed with respect to the driving unit and the tension releasing part.

2. The automatic belt tension apparatus according to claim 1, wherein the tension applying part comprises:
a swing shaft having ends supported at a frame;
a tension roller selectively coming in contact with a second surface of the belt; and
a swing arm, fixed on the swing shaft, and rotatably supporting the tension roller.

3. The automatic belt tension apparatus according to claim 2, wherein the tension applying part further comprises a first elastic member exerting a first elastic rotating force on the swing arm, to swing the tension roller in a first direction of contacting with the second surface of the transfer belt, installed with respect to the swing shaft, the frame, and the swing arm.

4. The automatic belt tension apparatus according to claim 3, wherein the first elastic member comprises a first tension spring, installed with respect to the swing shaft, and having ends supported at the frame and the swing arm, respectively.

5. The automatic belt tension apparatus according to claim 3, wherein the tension releasing part comprises a second elastic member exerting a second elastic rotating force on the swing arm, to swing the tension roller in a second direction, opposite the first direction, installed with respect to the frame and the swing arm.

6. The automatic belt tension apparatus according to claim 5, wherein the second elastic member comprises a second tension spring, installed with respect to the swing arm, and having ends supported at the frame and the swing arm, respectively.

7. The automatic belt tension apparatus according to claim 6, wherein the second elastic rotating force of the second tension spring is greater than the first elastic rotating force of the first tension spring, so that the tension roller swings in the second direction, and thereby is biased to not apply the predetermined tension to the belt.

8. The automatic belt tension apparatus according to claim 2, wherein the tension actuating part comprises:
a tension gear installed on the driving unit;
a power transmitting gear train comprising a plurality of power transmitting gears connected with the tension gear; and
a tension clutch installed on the swing shaft and transmitting a driving force transmitted to the power transmitting gear train from the tension gear, to the swing shaft only when the driving force is in a range of a predetermined load torque.

9. The automatic belt tension apparatus according to claim 8, wherein the tension clutch comprises:
a clutch gear, rotatably installed on the swing shaft to engage with the power transmitting gear train, and having a first clutch boss extended in an axial direction;
a bushing having a second clutch boss fixed on the swing shaft; and
a clutch spring coiled on outer circumferential surfaces of the first clutch boss of the clutch gear and the second clutch boss of the bushing, and when the driving force is transmitted from the power transmitting gear train to the clutch gear, transmitting the driving force to the bushing fixed on the swing shaft only when a driving load of the clutch gear is in the range of the predetermined load torque.

10. The automatic belt tension apparatus according to claim 9, wherein the range of the predetermined load torque of the clutch gear is set such that the tension roller, fixed on the swing shaft through the swing arm, applies the predetermined tension to the belt against a second elastic member of the tension releasing part.

11. The automatic belt tension apparatus according to claim 1, wherein the belt comprises a transfer belt, to receive a developer image formed on at least one photosensitive drum at the image adhesion face thereof, and to transfer the developer image onto a recording medium.

12. The automatic belt tension apparatus according to claim 1, wherein the belt comprises an intermediate transfer belt, to receive a developer image formed on at least one photosensitive drum at the image adhesion face thereof, and to transfer the developer image onto a transfer roller, to transfer the developer image onto a recording medium.

13. The automatic belt tension apparatus according to claim 1, wherein the belt comprises a photosensitive belt to form a toner developer image at the image adhesion face thereof.

14. An automatic belt tension apparatus of an image forming device including a frame, a belt, and a driving unit selectively driving the belt, the automatic belt tension apparatus comprising:
a tension applying part to selectively apply tension to the belt;
first and second elastic members oppositely biasing the tension applying part to contact and separate from the belt, respectively; and
a tension actuating part, selectively transmitting a driving force from the driving unit to the tension applying part to apply a predetermined tension to the belt.

15. The automatic belt tension apparatus according to claim 14, wherein the tension applying part comprises:
a swing arm, rotatably connected to the frame;
a tension roller, rotatably positioned on the swing arm to selectively apply tension to the belt,
wherein the first and second elastic members bias the swing arm.

16. The automatic belt tension apparatus according to claim 15, wherein the tension applying part further comprises:
a swing shaft rotatably connected to the frame,
wherein the swing arm is connected to the swing shaft.

17. The automatic belt tension apparatus according to claim 15, wherein:
the first elastic member comprises a first tension spring having ends respectively supported at the frame and the swing arm; and
the second elastic member comprises a second tension spring having ends respectively supported at the frame and the swing arm.

18. The automatic belt tension apparatus according to claim 14, wherein the bias of the second elastic member is greater than the bias of the first elastic member.

19. The automatic belt tension apparatus according to claim 14, wherein when the driving part is not driving the belt, the second elastic member overcomes the bias of the first elastic member to separate the tension applying part from the belt.

20. The automatic belt tension apparatus according to claim 14, wherein the tension actuating part transmits the driving force from the driving unit to the tension applying part when the driving force is within a predetermined range.

21. The automatic belt tension apparatus according to claim 16, wherein the tension actuating part comprises:
a tension gear installed on the driving unit transmitting the driving force; and
a tension clutch installed on the swing shaft and transmitting the driving force when the driving force is within a predetermined range.

22. The automatic belt tension apparatus according to claim 21, wherein the tension actuating part further comprises:
a power transmitting gear train, having at least one power transmitting gear, and transmitting the driving force from the tension gear to the tension clutch.

23. The automatic belt tension apparatus according to claim 21, wherein the tension clutch comprises:
a clutch gear, rotatably installed on the swing shaft, having a first clutch boss, and receiving the driving force;
a bushing fixed on the swing shaft and having a second clutch boss; and
an elastic clutch member transmitting the driving force from the first clutch boss to the second clutch boss when the driving force is within the predetermined range.

24. The automatic belt tension apparatus according to claim 23, wherein:
the elastic clutch member is a clutch spring coiled on outer circumferential surfaces of the first clutch boss and the second clutch boss;
the clutch gear comprises a first support;
a first end of the clutch spring is slipably supported on the first support such that the clutch spring only transmits the driving force to the second clutch boss when the driving force is within the predetermined range.

25. The automatic belt tension apparatus according to claim 24, wherein:
the bushing comprises a second support; and
a second end of the clutch spring is one of slipably supported and fixedly supported on the second support.

26. The automatic belt tension apparatus according to claim 24, wherein:
the first support has one of a circular-shaped concavo-convex groove and a plurality of spaced apart grooves circumferentially positioned adjacent to an inner edge of the outer circumferential surface of the first boss.

27. The automatic belt tension apparatus according to claim 24, wherein the tension clutch further comprises a clutch ring, disposed to enclose the clutch spring.

28. The automatic belt tension apparatus according to claim 14, wherein:
the belt comprises a transfer belt, receiving a developer image formed on at least one photosensitive drum at an image adhesion face thereof, and transferring the developer image onto a recording medium.

29. The automatic belt tension apparatus according to claim 14, wherein:
the belt comprises an intermediate transfer belt, receiving a developer image formed on at least one photosensitive drum at an image adhesion face thereof, and transferring the developer image onto a transfer roller, to transfer the developer image onto a recording medium.

30. The automatic belt tension apparatus according to claim 14, wherein the belt comprises a photosensitive belt to form a toner developer image at the image adhesion face thereof.

31. An automatic belt tension apparatus of an image forming device including a frame, a belt, and a driving unit, the automatic belt tension apparatus comprising:
a swing arm, rotatably connected to the frame;
a tension roller, positioned on the swing arm, and selectively contacting the belt;
a first elastic member biasing the swing arm in a first direction;
a second elastic member biasing the swing arm in a second direction, opposite the first direction; and
a tension actuating part, transmitting a torque load from the driving unit to the swing arm, to overcome the bias of the second elastic member and apply a predetermined tension to the belt, via the tension roller, when the torque load is within a predetermined range.
